(19) United States
(12) Patent Application Publication
(10) Pub. No.: US 2007/0140046 A1
(43) Pub. Date: Jun. 21, 2007

(54) Multiple-stream annular fluid processor

(75) Inventors: Mark Serafin, Apple Valley, MN (US); Neal K. Nelson JR., Stillwater, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/314,574

(22) Filed: Dec. 20, 2005

(51) Int. Cl. B01F 5/02

(52) U.S. Cl. 366/162.4; 366/176.1

(57) ABSTRACT

The disclosure is directed to a high pressure fluid processing device for mixing, reacting, or otherwise combining fluids. The fluid processing device includes opposing, annular flow channels. A first fluid enters the fluid processing device and flow through one annular flow channel while the second fluid enters the fluid processing device and flow through another annular flow channel. The opposing flows of fluids collide with one another within the flow channels, and exit through an outlet.

### TECHNICAL FIELD

The disclosure relates to fluid processing and, more particularly, high pressure fluid processing devices.

### BACKGROUND

The creation and processing of fluids in a fluid mixture is desirable for a variety of industrial processes. For example, fluids may be mixed, reacted or otherwise combined to form emulsions, suspensions or solutions. As an example, fluids may be mixed to form coatings, inks, paints, abrasive coatings, fertilizers, pharmaceuticals, biological products, agricultural products, foods, beverages, and the like. For some of these products, such as colloidal dispersions, the size and uniformity of dispersed phases can be extremely important.

To produce dispersions in a desired size range, industrial dispersion processing techniques make use of one or more fluid processing devices. A fluid processing device processes the fluid mixture in a manner that subjects dispersed phases, such as particles or other units of microstructure, to intense energy dissipation through a combination of intense shear and extensional forces. In this manner, a smaller, more uniformly sized dispersed phase is created in the colloidal dispersion.

One example of a dispersion is a magnetic dispersion used in the coating of magnetic media, such as magnetic disks, magnetic tape or other magnetic media used for data storage. For magnetic media, the mixture may contain magnetic particles and a polymeric binder carried in a solvent. A magnetic coating process involves application of the mixture to a substrate, followed by a drying process to remove the solvent. To ensure data storage reliability, uniformity of the magnetic particles within the dispersion is desirable.

### SUMMARY

The disclosure is directed to a high pressure, multi-stream, annular fluid processing device for combining fluids. The fluid processing device may be applicable to the mixture, reaction or combination of fluids containing one or more dispersed phases such as particulate structures. In this case, the fluid processing device may also be referred to as a dispersion processing device, which is used to mix, react or create a dispersed phase or other units of microstructure.

The fluid processing device may be useful in reducing the size of particles or other units of microstructure in one or more fluid mixtures and combining the mixtures to form dispersions, such as emulsions or suspensions. Alternatively, the fluid processing device may be applicable to combination of fluids that do not carry dispersed phases, including the combination of fluids to form solutions. In either case, the fluid processing device permits combination of two different fluids having different compositions to form a new combined product.

The fluid processing device includes opposing, coaxial, annular fluid flow channels. For example, a first fluid flows from a fluid path into a first annular flow channel while a second fluid flows from another fluid path into a second annular flow channel. The fluids in the two annular flow channels move in opposite directions, i.e., toward one another, and impinge. In particular, the two annular flow channels flow toward one another and collide such that the first and second fluids mix, react, or otherwise combine with one another. When applied to a dispersion, the shear and extensional forces generated by the collision of the fluid annuli can create a smaller, narrower size distribution of dispersed phases.

In one embodiment, the invention provides a fluid processing device comprising a first input channel that receives a first fluid, a second input channel that receives a second fluid, a first annular flow channel coupled to the first input channel that delivers the first fluid in a first direction, a second annular flow channel coupled to the second input channel that delivers the second fluid in a second direction opposing the first direction such that the first and second fluids collide and combine with one another, and an outlet that delivers a combined product of the first and second fluids.

In another embodiment, the invention provides a fluid processing system comprising one or more pumps that pump at least of one of a first fluid and a second fluid, one or more heat exchangers that change the temperature of at least one of the first fluid and the second fluid, and a fluid processing device that processes the first fluid and the second fluid. The fluid processing device includes a first annular flow channel that delivers the first fluid in a first direction, a second annular flow channel that delivers the mixed fluid in a second direction opposing the first direction such that the first and second fluids collide and combine with one another, and an outlet that delivers a combined product of the first and second fluids.

In an additional embodiment, the invention provides method comprising directing a first fluid into a first annular flow channel that delivers the first fluid in a first direction, directing a second fluid into a second annular flow channel that delivers the second fluid in a second direction opposing the first direction such that the first and second fluids collide and combine with one another, and delivering a combined product of the first and second fluids via an outlet.

In another embodiment, the invention provides a fluid processing system comprising one or more pumps that pump at least of one of a first fluid and a second fluid, one or more heat exchangers that change the temperature of at least one of the first fluid and the second fluid, a fluid processing device that processes the first and second fluids, the fluid processing device including a first annular flow channel that delivers the first fluid in a first direction, and a second annular flow channel that delivers the second fluid in a second direction opposing the first direction such that the first and second fluids collide and combine with one another, and an outlet that delivers a combined product of the first and second fluids, wherein the fluids flow through the one or more heat exchangers before flowing into the fluid processing device.

The invention, in various embodiments, may be capable of providing a number of advantages. In general, the disclosure may improve industrial manufacturing of coatings, inks, paints, abrasive coatings, fertilizers, foods, beverages, pharmaceuticals, biological products, agricultural products, or the like. The use of opposing, annular flow channels may improve the processing of the dispersed phase from more than one fluid, producing a dispersed phase with reduced size and possibly enhanced size uniformity.

Annular flow channels may enhance the energy dissipation due to wall shear forces in the fluid processing device, e.g., because of increased wall surface area for a given flow channel. A fluid processing device in accordance with this disclosure may be capable of handling input pressures as high as approximately 40,000 psi (275 MPa). The annular flow channels may also provide increased uniformity in mixing for more than one fluid at the end of each flow channel.

In addition, the disclosure may provide an automatic anti-clogging action that can improve the industrial manufacturing process by reducing or avoiding the need to manually clean and de-clog the fluid processing device. Thus, the automatic anti-clog action can reduce maintenance costs and avoid down-time of the manufacturing system.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram of an exemplary fluid processing system utilizing an annular fluid processing device.

FIG. 2 is a cross-sectional side view of an exemplary annular fluid processing device with a channel separator.

FIG. 3 is a cross-sectional side view of an exemplary annular fluid processing device with separate channels.

FIG. 4 is a cross-sectional side view of a portion of the annular fluid processing device of FIG. 2 including annular flow channels with a movable rod defining an inner diameter of a flow annulus.

FIG. 5 is a cross-sectional side view of a portion of the annular fluid processing device of FIG. 2 including annular flow channels with a fixedly attached rod defining an inner diameter of a flow annulus.

FIG. 6 is a cross-sectional side view of a portion of the annular fluid processing device of FIG. 2 including annular flow channels with a circumferential outlet.

FIG. 7 is a cross-sectional side view of a portion of the annular fluid processing device including annular flow channels with a circumferential outlet and a rod fixedly attached to form the inner surface of the flow channels.

FIGS. 8 and 9 are conceptual perspective views of a cylindrical rod inside one or more flow path cylinders to define annular flow channels for fluid processing.

### DETAILED DESCRIPTION

The disclosure is directed to a high pressure fluid processing device for combining fluids. The fluid processing device may be applicable to the combination of fluids containing one or more dispersed phases. In general, a dispersed phase may include dispersed particles, colloidal dispersions, or other matter separated by a phase boundary. The fluid processing device mixes, reacts or otherwise combines two or more fluids to produce a combined product of the fluids.

For example, the fluid processing device may be useful in reducing the size of dispersed particles or other units of microstructure in one or more fluid mixtures and combining the fluids to form dispersions, such as emulsions or suspensions. In addition, the fluid processing device may be applicable to a combination of fluids that do not carry particulate structures, including the mixture of fluids to form solutions. As examples, the fluid processing device may be used for preparation of coatings, inks, paints, abrasive coatings, fertilizers, foods, beverages, pharmaceuticals, biological products, agricultural products, or the like.

The fluid processing device makes use of opposing, annular fluid flow channels. For example, a first fluid is directed from a fluid path into a first annular flow channel while a second fluid is directed from another fluid path into a second annular flow channel. The two annular flow channels cause the fluids to flow toward one another and collide with one another such that the first and second fluids mix, react or otherwise combine with one another. The flow channels are coaxial and may flow into opposite ends of a common cylinder, e.g., meeting at the middle of the cylinder.

An outlet adjacent to the point at which the first and second annular flow channels collide allows a fluid mixture flowing down the annular flow channels to be combined and expelled. The shear and extensional forces of the collision of the first fluid flowing down one annular flow channel with the second fluid flowing down the other annular flow channel supports mixing and/or reaction. For dispersions, the shear and extensional forces may be sufficient to cause dispersed phases, such as particles, to be reduced in size, and to cause the fluids to mix, react or combine together prior to expulsion through the outlet.

A rod may be positioned within the flow path cylinder. The rod may be cylindrical, and defines the inner diameter of the annular flow channels. In particular, an inner diameter of the flow path cylinder defines an outer diameter of the annular flow channels, and an outer diameter of the cylindrical rod positioned inside the flow path cylinder defines an inner diameter of the annular flow channels.

In some embodiments, the cylindrical rod may be free to move and vibrate within the flow path cylinder, which can provide an automatic anti-clog mechanism. If particles in the fluids become clogged inside the fluid processing device, the cylindrical rod can move or vibrate as a result of pressure imbalance caused by the clog. The movement of the cylindrical rod, in turn, may help to clear the clogged material and restore the pressure balance within the fluid processing device. In other embodiments, the rod may be fixed within the cylinder to prevent rod movement. In this case, controlled pressure pulses may be applied to serve as an anti-clog mechanism.

The outlet may be located approximately near the center or mid-point along the length of the flow path cylinder, and may have a fixed or adjustable width. In the case where the width of the outlet is adjustable, the outer diameter of the annular flow channels may be defined by the inner diameter of two cylinders positioned in series, with the outlet being defined as the lateral gap between the two cylinders. In that case, the cylindrical rod extends inside each of the two cylinders to define the inner diameter of the annular flow channels. The outlet size may be adjusted by moving one or both of the cylinders laterally relative to the other.

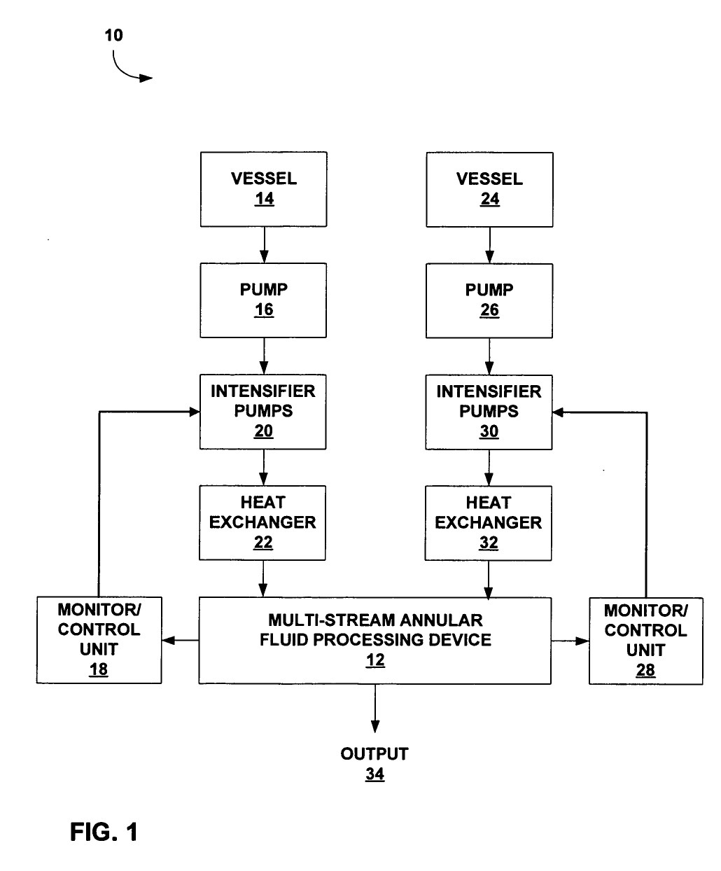

FIG. 1 is a block diagram of an exemplary fluid processing system 10 utilizing a multiple-stream annular fluid processing device 12 in accordance with an embodiment of the invention. System 10 permits two or more fluids to be presented to annular fluid processing device 12. Annular fluid processing device 12 receives a first fluid via a first annular flow channel and a second fluid via another fluid path into a second annular flow channel. Each fluid may contain a single fluid product or be a combination of one or more fluid products. In addition, in some embodiments, one or both fluids may carry particulate structures, although system 10 also may be useful with fluids that do not carry particulate structures.

The two annular flow channels are coaxial and flow toward one another. For example, the fluids may be introduced into the flow channels at opposite ends of a cylinder, and meet one another substantially within the middle of the cylinder. The flow channels may have identical inner and outer diameters. An outlet extends through the cylinder where the first and second annular flow channels collide, allowing fluids flowing down the annular flow channels to be mixed, reacted, or otherwise combined, and then expelled. The shear and/or extensional force of the collision of the first fluid flowing down one annular flow channel with the second fluid flowing down the other annular flow channel supports combination of the fluids prior to expulsion through the outlet.

For dispersions, the shear and/or extensional forces may cause the dispersed phase(s) in the fluids to be reduced in size, producing smaller particles, and also cause the fluids to mix, react or otherwise combine together prior to expulsion through the outlet. Fluid processing device 12 also may subject the fluids to wall extensional forces at the beginning and throughout the annular flow channels, further promoting mixing or reaction and a more consistently sized dispersed phase. In some particular applications, one or both fluids may include a dispersion of magnetic particles, e.g., for coating of magnetic data storage media. However, the invention is not so limited.

As shown in FIG. 1, system 10 includes vessels 14 and 24, pumps 16 and 26, intensifier pumps 20 and 30, heat exchangers 22 and 32, annular fluid processing device 12, and output 34. Monitor/control units 18, 28 may be provided to monitor temperature, pressure, or other parameters within processing device 12, and control inlet valves, intensifier pumps 20, 30, or both to adjust the pressure of the fluids delivered by the pumps. Vessels 14, 24 may include mixers to mix the fluids delivered by pumps 16, 26, respectively. In other embodiments, vessels 14, 24 may not include mixers. For example, in some cases, the fluids within vessels 14, 24 may be premixed or not require mixing. Annular fluid processing device 12 includes opposing annular flow channels, as further described herein.

System 10, with fluid processing device 12, may be particularly useful in processing coating solutions having high concentrations of solids. For example, system 10 may be used to process coating solutions having solid particle contents of greater than approximately ten percent by weight, although the system is not limited in that respect. For some industrial applications, a solution may carry hard, substantially non-compliant particles, such as magnetic pigments used for coating of magnetic media. System 10 may also be used for other industrial processes including, for example, the preparation of inks, paints, abrasive coatings, fertilizers, foods, beverages, pharmaceuticals, biological products, agricultural products, other media, and the like. In some embodiments, system 10 may be implemented to produce fluids with small particulates of consistent size, such as magnetic pigment particles. More generally, system 10 may be implemented to mix, react or combine two or more fluids having different compositions to produce a combined product of the fluids.

System 10 may initially prepare a first fluid and a second fluid before combining the two fluids and processing them together in annular fluid processing device 12. Each fluid uses a separate set of components during the process. The first fluid is contained within vessel 14 before being pumped by pump 16. Intensifier pump 20 increases the pressure of the first fluid and forces the fluid through heat exchanger 22 to heat or cool the mixture. The first fluid is then sent into annular fluid processing device 12 where it meets the second fluid. The second fluid is contained within vessel 24 before being pumped by pump 26. Intensifier pump 30 increases the pressure and delivers the second fluid to heat exchanger 32 before the fluid enters annular fluid processing device 12. Heat exchangers 22, 32 may be capable of operating in high pressure environments. Output 34 consists of the combined product containing the first fluid and the second fluid.

Heat exchangers 22, 32 are placed before annular fluid processing device 12 such that the temperature of the respective fluid is changed prior to introduction into the annular fluid processing device 12. Each heat exchanger 22, 32 may have a conventional design. For example, a heat exchanger 22, 32 may include a helical fluid carrying tube that passes through a heating or cooling medium, such as heated or cooled liquid or vapor. An example of a suitable heat exchanger is described in U.S. Pat. No. 5,927,852 to Serafin. Placement of a heat exchanger after annular fluid processing device 12 may be optional, but may not be necessary in many applications. Instead, in some embodiments, heat exchangers 22, 32 may be placed only prior to annular fluid processing device 12. Notably, in some embodiments, there is no need for re-pressurization of the fluids between the initial pressurization by intensifier pump 20 or 30, and introduction to annular fluid processing device 12.

In some embodiments, use of a heat exchanger prior to the annular fluid processing device 12 may be applicable not only to a device that processes multiple streams of fluids, but also a single stream or multiple streams of the same fluid, instead of different fluids. In other words, the first fluid and second fluid may have different compositions or substantially identical compositions. As an example, fluid processing device 12 may have a single inlet to receive a single fluid that is bifurcated into multiple streams within the fluid processing device 12. In preferred embodiments, however, fluid processing device 12 is equipped with multiple inlets to process multiple streams of a fluid with a substantially identical composition, or different fluids having different compositions, as described herein.

In some embodiments, more than two fluids may be prepared and sent to annular fluid processing device 12 in a manner similar to the first and second fluids. A plurality of fluids may be beneficial for certain applications where fluids need to be prepared under different conditions or the timing of the addition of certain fluids is integral to the final combined product leaving processing device 12.

One or more pumps 16 serve to draw the fluids from vessel 14 and deliver the fluids to intensifier pump 20. Again, in some embodiments, the fluids may not carry particulate structures. A mixer, optionally provided within vessel 14, mixes the fluid. For example, the mixer may comprise a planetary mixer, a double planetary mixer, or the like. Additional materials may also be added in stages. Accordingly, vessel 14 may or may not contain all of the ingredients of the first fluid. Moreover, in some embodiments, the first fluid may include two or more mixed fluids, with or without dispersed phases such as particles mixed in the fluids. Vessel 24 and pump 26 used to process the second fluid may be substantially similar to vessel 14 and pump 16 used to process the first fluid.

One or more intensifier pumps 20, 30 each may be capable of generating approximately 100 to 40,000 psi (690 kPa to 275 MPa) of fluid pressure. Fluid processing device 12, as described herein, may be capable of handling pressures greater than approximately 10,000 psi (68,950 kPa), greater than approximately 30,000 psi (207 MPa), or greater than approximately 40,000 psi (275 MPa). Intensifier pump 30 used with the second fluid may be substantially similar to intensifier pumps 20 used on the first fluid.

Following pressurization by intensifier pump 20, the first fluid flows through heat exchanger 22 to dissipate excess thermal energy generated by intensifier pump 20. Heat exchanger 32 used to dissipate excess thermal energy from the second fluid is substantially similar to heat exchanger 22. In other embodiments, heat exchangers 22 and 32 may increase the thermal energy in the first or second fluids. Alternatively, in some embodiments, heat exchangers 22 and 32 may be located downstream of annular fluid processing device 12. In a preferred embodiment, however, heat exchangers 22, 32 are located upstream of fluid processing device 12. Heat exchangers 22 and 32 may be suited for high pressure applications that may include pressures produced by intensifier pumps 20 and 30.

The first and second fluids are delivered to fluid processing device 12 after flowing though heat exchangers 22 and 32, respectively. Fluid processing device 12 generates shear and extension forces, producing energy dissipation to reduce the size of the particles in the first and second fluids. In other words, fluid processing device 12 serves to reduce the size of the dispersed phase in the first and second fluids, producing smaller-sized particles, and thereby producing a finely dispersed solution of particles having a desired size range. The first and second fluids are also combined into a final product, at output 34, at the same time that the dispersed phases from each fluid are reduced in size. In some embodiments, additional heat exchangers (not shown) may be used to extract excess thermal energy generated in the mixture during processing. However, additional heat exchangers may not be necessary in various applications.

An optional filtration element may be used to filter particles in the final combined product. For example, the filtration element may comprise one or more porous membranes, mesh screens, or the like, to filter the final combined product. The output of the filtration element may then be used, e.g., for coating, packaging or some other end use. In some cases, for example, the output may be packaged and sold, e.g., in the case of coatings, inks, paints, dyes, fertilizers, foods, beverages, pharmaceuticals, biological products, agricultural products, or the like. A back pressure regulator (not shown) may be added downstream of the filtration element to help maintain substantially constant pressure in system 10. In some embodiments, system 10 may provide a return path to a recovery vessel for any recovered or unused portion of the output 34, i.e., any portion not used in the applicable coating, packaging, or manufacturing process. Alternatively, the final combined product may be directed to another vessel (not shown) for storage or further fluid processing.

Fluid processing device 12 accepts multiple streams of fluids, and makes use of opposing, coaxial, annular fluid flow channels. Fluid processing device 12 may include a flow path cylinder and a rod positioned inside the flow path cylinder. Annular flow channels are defined by the outer diameter of the rod and the inner diameter of the flow path cylinder. Specifically, two annular flow channels flow toward one another through the cylinder, and meet within the cylinder, such as near the center of the cylinder. The opposing forces created by the collision of the fluids transmitted along the annular flow channels create shear forces. The fluid flows oppose one another within the cylinder. An outlet extends through the cylinder where the fluids flowing down the two annular flow channels collide, allowing the resulting combined product to be expelled through the outlet. The shear and extensional forces during the collision of the fluids causes a reduction in size of the dispersed phase prior to expulsion through the gap, e.g., producing particles of reduced size. Moreover, annular flow channels may enhance wall shear forces in fluid processing device 12 by increasing surface area associated with a given flow channel.

The rod may be cylindrical, and can be positioned within the flow path cylinder to define the inner diameter of the annular, coaxial flow channels. In other words, an inner diameter of the flow path cylinder defines an outer diameter of the annular flow channels, and an outer diameter of the cylindrical rod positioned inside the flow path cylinder defines an inner diameter of the annular flow channels. In some embodiments, the cylindrical rod may be free to move and vibrate within the flow path cylinder, which can provide an automatic anti-clogging action. In other embodiments, the cylindrical rod may be fixedly attached to a structure within processing device 12 to inhibit vibrations during fluid movement. Also, the outlet may be formed by an adjustable gap defined by two separate flow path cylinders positioned on a common axis in series, with the rod extending into both cylinders. In that case, the first and second fluids flow down the respective coaxial cylinders in opposing directions and meet at the adjustable gap defined by separation of the two separate flow path cylinders.

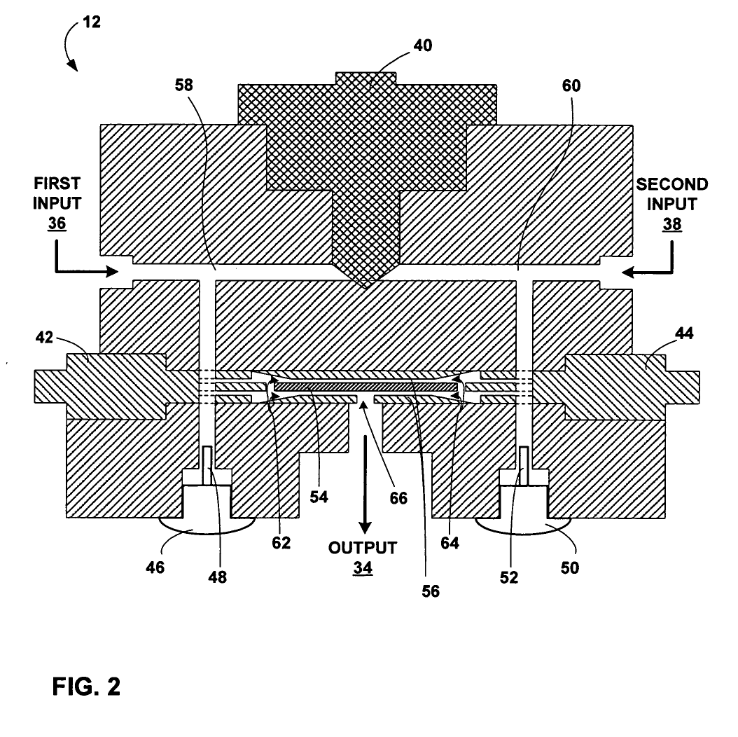

FIG. 2 is a cross-sectional side view of exemplary annular fluid processing device 12 with a channel separator 40 for use in system 10 as described above. As previously described, fluid processing device 12 may be capable of handling pressures up to or greater than approximately 40,000 psi (275 MPa). As an example, a first fluid comprising a solvent and one or more different types of dispersed phase, such as hard particles, dispersed in the solvent can be introduced to device 12 at first input 36. Similarly, a second fluid comprising a solvent and one or more different types of dispersed phase, such as hard particles, dispersed in the solvent can be introduced to device 12 at second input 38. The solvents and dispersed phases that make up the first fluid and the second fluid may be similar or different with respect to each fluid. Alternatively, at least one of the fluids may include one or more solvents with or without additional dispersed phases mixed therein. Also, in some embodiments, at least one of the fluids may be an aqueous solution. In any case, the first fluid is contained within flow channel 58 while the second fluid is contained within flow channel 60. Channel separator 40 prevents flow channels 58 and 60 from merging upon introduction into device 12. Instead, flow channels 58 and 60 feed into opposing sides of flow path cylinder 56, which defines annular flow channels for the first and second fluids.

In particular, the inner diameter of flow path cylinder 56 defines an outer diameter of annular flow channels that feed toward one another to meet at the center of cylinder 56. Rod 54 is positioned inside flow path cylinder 56, and defines first and second ends. A first end of rod 54 extends into annular flow channel 62 and a second end of rod 54 extends into second annular flow channel 64. Ordinarily, rod 54 is concentric with the annular flow channels 62, 64, having a center axis that is aligned with the central longitudinal axis of flow path cylinder 56. The outer diameter of rod 54 defines the inner diameter of annular flow channels 62 and 64. Accordingly, flow channels 58 and 60 respectively feed into annular flow channels 62 and 64 defined by flow path cylinder 56 and rod 54. In some embodiments, the various flow paths and channels within device 12 may be machined using a common block of material.

The first fluid flows along annular flow channel 62, e.g., from left to right in FIG. 2, while the second fluid flows along annular flow channel 64, e.g., from right to left in FIG. 2. The two fluids collide at or near outlet 66 formed in flow path cylinder 56, e.g., approximately at the lateral center of cylinder 56. Outlet 66 is ported through the wall of cylinder 56 at the midpoint along the length of the cylinder. The energy dissipation from the shear and extensional forces of the collision of the two fluids flowing along annular flow channels 62 and 64 causes a reduction in size of the dispersed phase or phases. For example, agglomerations in each fluid can be broken up into smaller sized particles. Additionally, the first fluid and the second fluid are mixed, reacted or combined to form a newly combined final fluid product. Moreover, annular flow channels 62 and 64 may enhance wall shear forces in fluid processing device 12 by increasing surface area associated with flow channels 62 and 64. In this manner, fluid processing device 12 can be used to reduce the size dispersed phase, such as particles, in each of the two fluids. The final fluid product is expelled through outlet 66 and exits fluid processing device 12 (as indicated at output 34).

As further shown in FIG. 2, fluid processing device 12 may include pressure sensors 46 and 50 to measure the pressure of each fluid within fluid processing device 12, as well as temperature sensors 48 and 52 to measure the input temperature of the first and second fluids. Sensors 48 and 52 may comprise thermocouples, thermistors, or the like. A controller, such as monitor/control unit 18 or 28 (FIG. 1), may receive the pressure and temperature measurements, and adjust the pressure of the fluids at first and second inputs 36, 38 via one or more regulator valves to maintain a desired pressure within fluid processing device 12. Alternatively, the controller may adjust the pressure of one or both of intensifier pumps 20, 30. Similarly, the controller may receive temperature measurements, and cause adjustment of the temperature to one or more fluids, as needed, to maintain a desired input temperature for each fluid into fluid processing device 12. It is generally desirable to maintain substantially identical mixture flow pressures down the respective annular flow channels 62 and 64 to ensure the desired impingement energy dissipation.

In some embodiments, temperature sensors 48 and 52 may be located at different positions within fluid processing device 12. For example, temperature sensors 48 and 52 may be located within channel separator 40 with sensor 48 measuring the temperature of flow channel 58 and sensor 52 measuring the temperature of flow channel 60. Alternatively, pressure sensors 46 and 50 may be located at other locations within fluid processing device 12.

Substantially identical flows of each fluid down their respective annular flow channels 62 and 64, e.g., in terms of pressure or temperature, are indicative of a non-clogged condition. Temperature monitoring, in particular, can be used to identify when a clogged condition occurs, and may be used to identify when anti-clogging measures should be taken, e.g., application of a pulsated short term pressure increase in one or both input flows to clear the clog. For example, monitor/control unit 18, 28 (FIG. 1) may be provided to sense parameters such as temperature or pressure and control the pressure of the fluids delivered into the annular flow channels 62, 64 to unclog the flow channels. Although separate monitor/control units 18, 28 are shown in FIG. 1 for the separate flow channels, a single monitor/control unit may be configured to monitor parameters and control pressure for both flow channels.

Gland nuts 42 and 44 may be used to secure flow path cylinder 56 in the proper location within fluid processing device 12. Moreover, gland nuts 42 and 44 can be formed with channels (indicated by the dotted lines) that allow fluid to flow freely through flow channels 58 and 60 and into annular flow channels 62 and 64.

Rod 54 may be cylindrically shaped, although the disclosure is not necessarily limited in that respect. For example, other shapes of rod 54 may further enhance wall shear forces in the annular flow channels. Alternative shapes may include a circular cylinder, oval cylinder or polygon cylinder. Rod 54 may be free to move and vibrate within the flow path cylinder 56. In particular, rod 54 may be unsupported within flow path cylinder 56. Free movement of rod 54 relative to flow path cylinder 56 may provide an automatic anti-clogging action to fluid processing device 12. If dispersed phase, such as particles or agglomerations, in one or both of the fluids become clogged inside fluid processing device 12, e.g., at the edges of annular flow channels 62 or 64, rod 54 may respond to local pressure imbalances by moving or vibrating. For example, a clog within cylinder 56 or in proximity of annular flow channels 62 or 64 may result in a local pressure imbalance that causes rod 54 to move or vibrate. The movement and/or vibration of rod 54, in turn, may help to clear the clog and return the pressure balance within fluid processing device 12. In this manner, allowing rod 54 to be free to move and vibrate within the flow path cylinder 56 can facilitate automatic clog removal. In other embodiments, rod 54 may be fixed within fluid processing device 12.

To further improve clog removal, or permit clog removal when rod 54 is fixedly mounted, a pulsated short term pressure increase in the input flow at first input 36, second input 38 or both can be performed upon identifying a clog. For example, as mentioned above, temperature sensors 48 or 52 may identify temperature changes in flow channels 58 and 60, which may be indicative of a clogged condition. In response, monitor/control unit 18 or 28 (FIG. 1) may apply a short term pressure increase, e.g., a two-fold pressure increase for approximately a five second duration, may cause more substantial movement and/or vibration of rod 54 to facilitate clog removal. The pulsated short term pressure increase in one or both input flows may be performed in response to identifying a clogged condition, or on a periodic basis. For example, intensifier pumps 20 or 30 (FIG. 1) may be controlled by monitor/control units 18, 28, respectively, to adjust the input pressure of the respective first or second fluids to fluid processing device 12. Alternatively, monitor/control units 18, 28 may control inlet valves associated with device 12 the first and second fluids to selectively increase or decrease pressure and thereby unclog device 12. A short term pressure increase may be particularly useful in clearing clogs that affect both annular flow channels 62 and 64. In that case, the temperature of both input flow paths may be similar, but may increase because of the clog that affects both annular flow channels 62 and 64.

In different embodiments, outlet 66 may have a fixed or adjustable size. For example, outlet 66 may take the form of a gap with an adjustable width. Flow path cylinder 56 and rod 54 may define substantially constant diameters, or one or both of flow path cylinder 56 and rod 54 may define diameters that vary or change along the annular flow channels 62 and 64. The components of fluid processing device 12, including flow path cylinder 56 and rod 54 may be formed of a hard durable metallic material such as steel or a carbide material. As one example, flow path cylinder 56 and rod 54 may be formed of tungsten carbide containing approximately six percent tungsten by weight.

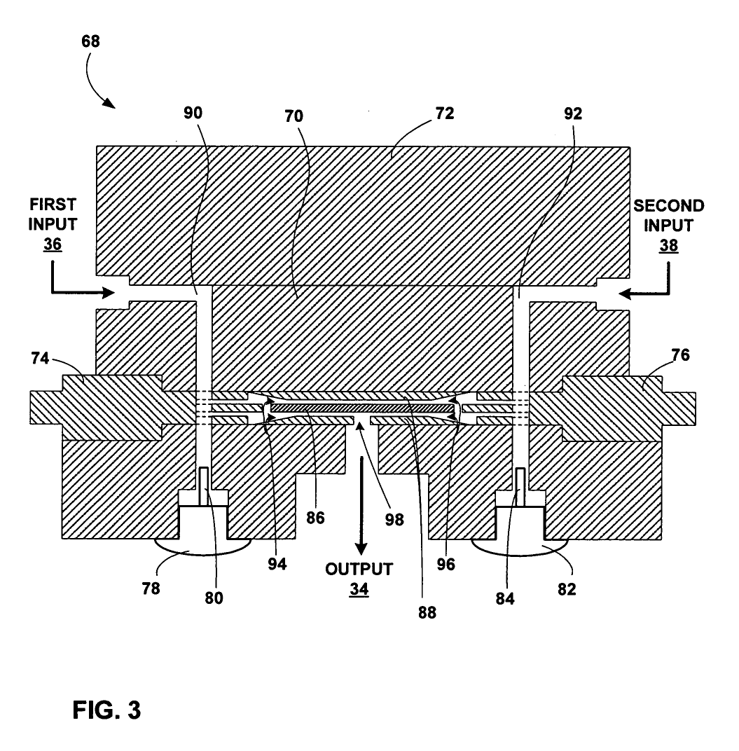

FIG. 3 is a cross-sectional side view of an exemplary annular fluid processing device with separate channels. As shown in FIG. 3, annular fluid processing device 68 is substantially similar to annular fluid processing device 12. Fluid processing device 68 includes first input 36 for flow path 90 and second input 38 for flow path 92. Blocks 70 and 72 are attached to form a portion of each flow path 90 and 92. Rod 86 is housed within flow path cylinder 88 to create annular flow channels 94 and 96. Outlet 98 is formed in the middle of flow path cylinder 88 to allow output 34 to exit device 12. Gland nuts 74 and 76 secure cylinder 88 within the proper location within flow processing device 12. Pressure sensors 78 and 82 monitor the pressures of each flow path 90 and 92, while temperature sensors 80 and 84 monitor the temperature of a first fluid within flow path 90 and a second fluid within flow path 92, respectively.

Annular fluid processing device 68 does not include the channel separator 40 that is included in device 12. Blocks 70 and 72 separate flow paths 90 and 92 of fluid processing device 68. Blocks 70 and 72 are sealed together to create flow paths 90 and 92 and prevent the flow paths from ever merging. In some embodiments, blocks 70 and 72 are comprised of one continuous piece of material to eliminate the need for sealing two separate blocks.

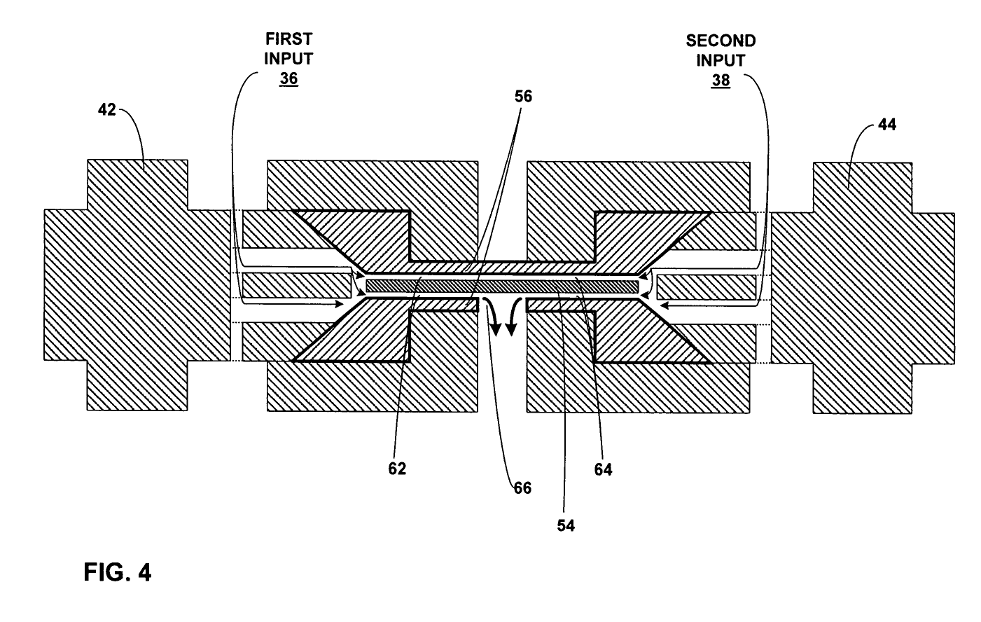

FIG. 4 is a cross-sectional side view of a portion of the annular fluid processing device 12 of FIG. 2 including annular flow channels. As shown in FIG. 4, the components may be used in either flow processing device 12 or flow processing device 68, while device 12 will be used as an example herein. Gland nuts 42 and 44 may be used to secure flow path cylinder 56 in the proper location within fluid processing device 12. Moreover, gland nuts 42 and 44 may be formed with channels (indicated by the dotted lines) that allow the first fluid to flow freely into annular flow channel 62 and the second fluid to flow freely into annular flow channel 64. The ends of flow path cylinder 56 may be formed to mate with gland nuts 42 and 44, e.g., by reciprocal threading, in order to facilitate securing of cylinder 56 in a precise location.

Again, annular flow channels 62 and 64 are defined by flow path cylinder 56 and rod 54. Flow path cylinder 56 may define a minimum width that remains substantially constant along the annular flow channels. Rod 54 may be cylindrically shaped, and can be free to move and vibrate within the flow path cylinder 56. Ordinarily, rod 54 is concentric with the annular flow channels, having a center axis that is aligned with the central longitudinal axis of flow path cylinder 56. Fluid dynamic forces and uniform balance of rod 54 can force the rod toward the lateral and longitudinal center of the annular flow channel. Movement and vibration of rod 54 within flow path cylinder 56 can facilitate automatic clog removal.

The following dimensions are provided for purposes of illustration, and should not be considered limiting of the invention as broadly embodied and described herein. In an exemplary embodiment, the inner diameter of flow path cylinder 56 may be in the range of approximately 0.290 inches to 0.00290 inches (7.37 mm to 0.0737 mm). For example, the inner diameter of flow path cylinder 56 may be approximately 0.0290 inches (0.737 mm). The outer diameter of rod 54 may be in the range of approximately 0.270 inches to 0.00270 inches (6.86 mm to 0.0686 mm). The outer diameter of rod 54 may be slightly smaller than the minimum inner diameter of flow path cylinder 56. For example, if the inner diameter of flow path cylinder 56 is approximately 0.0290 inches (0.737 mm), the outer diameter of rod 54 may be between approximately 0.0250 inches and 0.0280 inches (6.35 mm and 0.711 mm). Specifically, the outer diameter of rod 54 may be 0.0260, 0.0274, 0.0276, or 0.0278 inches (0.661, 0.696, 0.701, and 0.706 mm). Other sizes, widths and shapes of flow path cylinder 56 and rod 54 could also be used in accordance with the disclosure.

By way of example, the width of outlet 66 may be approximately between 0.0001 inches and 0.1 inches (0.00254 mm and 2.54 mm). As one example, the width of outlet 66 at the outer diameter of flow path cylinder 56 may be in a range of approximately 0.006 inches to 0.010 inches (0.152 mm to 0.254 mm). Outlet 66 may extend approximately 180 degrees around cylinder 56, or may extend to a lesser or greater extent, if desired. Other sizes and shapes of outlet 66 may also be used, particularly for different types of fluid processing applications.

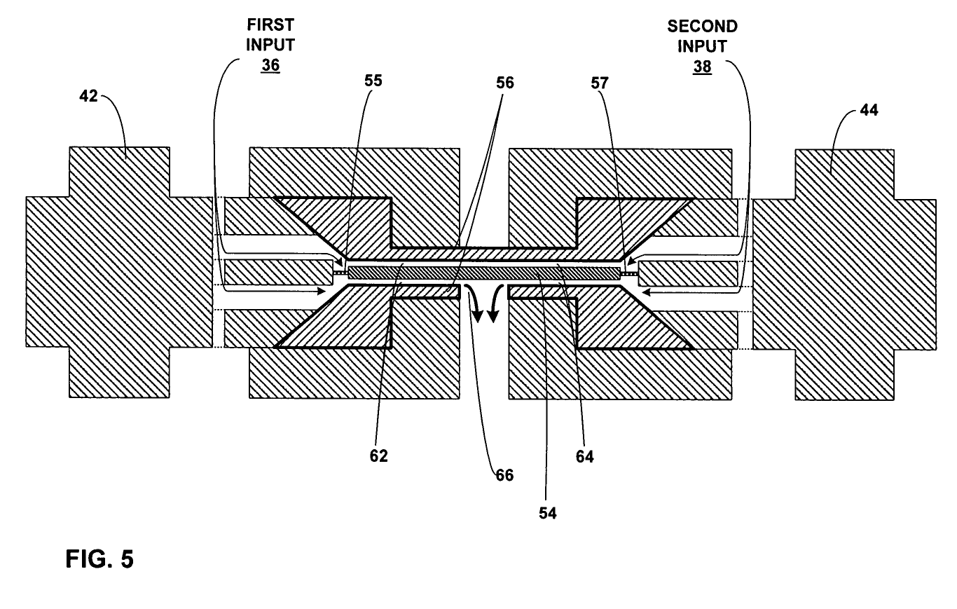

FIG. 5 is a cross-sectional side view of a portion of the annular fluid processing device 12 of FIG. 2 including annular flow channels with a rod fixedly attached to comprise the inner surface of the flow paths. FIG. 5 shows an alternative embodiment of FIG. 4, such that annular fluid processing device 12 includes rod 54 securely attached to rod supports 55 and 57 located along the longitudinal axis of rod 54. While rod supports 55 and 57 are located at each end of rod 54, other embodiments may include rod supports contacting rod 54 on any other surface. For example, one or more rod supports may be located around the circumference of rod 54 near an end or in the middle of cylinder 56. Rod supports 55 and 57 may be constructed in a cylindrical shape or other structure that secures rod 54. In other embodiments, rod supports 55 and 57 may be cables that are under tension to securely tether rod 54 within cylinder 56.

Rod supports 55 and 57 prevent rod 54 from moving or vibrating within cylinder 56. Fixedly attaching rod 54 to rod supports 55 and 57 may be beneficial in some applications where fluid processing device 12 may be incorporated. For example, vibration of rod 54 may be unwanted if constant shear forces are desired at all times within cylinder 56. If a clog occurs within cylinder 56, short pulses of greater pressure from first input 36 or second input 38 may unclog any flow path, such as annular flow channels 62 or 64. Alternately, rod supports 55 and 57 may allow rod 54 to slightly move within cylinder 56. This movement may be related to rod 54 flexing or pressure differences between the first and second fluids.

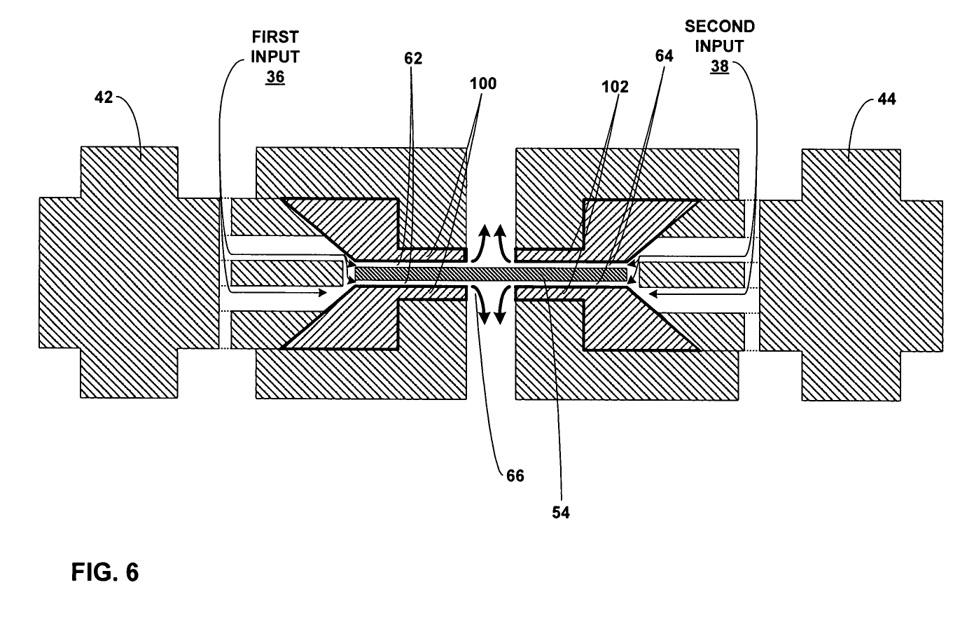

FIG. 6 is a cross-sectional side view of a portion of the annular fluid processing device 12 of FIG. 2 including annular flow channels with a circumferential outlet. The configuration of FIG. 6 may be substantially similar to that of FIG. 4 in terms of the shapes and sizes of the features. In FIG. 6, however, two flow path cylinders 100 and 102 collectively perform the function of the single flow path cylinder 56 illustrated in FIG. 4. Cylinders 100, 102 are positioned along a common axis, i.e., coaxially aligned. In the example of FIG. 6, the width of outlet 66 is adjustable, i.e., by adjusting the linear position of one or both cylinders 100, 102, relative to one another, along the common axis. In some embodiments, cylinders 100, 102 may be permitted to vibrate during operation. In preferred embodiments, however, cylinders 100, 102 are not free to vibrate once they are adjusted to a desired position.

The outer diameter of annular flow channels 62 and 64 is defined by the inner diameter of two cylinders 100 and 102 positioned in series, with outlet 66 being defined as the lateral gap 66 between both cylinders 100 and 102. In that case, rod 32 extends inside each of the two cylinders 100 and 102 to define the inner diameter of the annular flow channels 62 and 64. In other words, a first end of rod 54 defines an inner diameter of annular flow channel 62 and a second end of rod 54 defines an inner diameter of annular flow channel 64.

Outlet 66 may be adjusted by moving one of cylinders 100 or 102 laterally relative to the other of cylinders 100 or 102. Gland nuts 42 and 44 may facilitate this gap adjustment. In particular, gland nuts 42 and 44 may include threading to facilitate translational movement of gland nuts 42 and 44 relative to one another to adjust the position of cylinders 100 and 102 relative to one another and thereby adjust the size of outlet 66.

In the configuration of FIG. 6, outlet 66 extends the entire 360 degrees about cylinders 100 and 102 to form a circumferential outlet. If desired, a plug, a shield, or other mechanism to block fluid flow may be added to limit fluid output in some circumferential directions. Circumferential outlet 66 may aid in mixing, reacting or combining the first and second fluids once each fluid exits its respective cylinder 100 and 102. In some embodiments, the final combined product from circumferential outlet 66 may be directed to one or more channels perpendicular to rod 54. These one or more channels may be of any shape, including a cylindrical, square or rectangular shape. In addition, the diameter of the one or more channels may increase, decrease, or remain constant as the distance from outlet 66 increases.

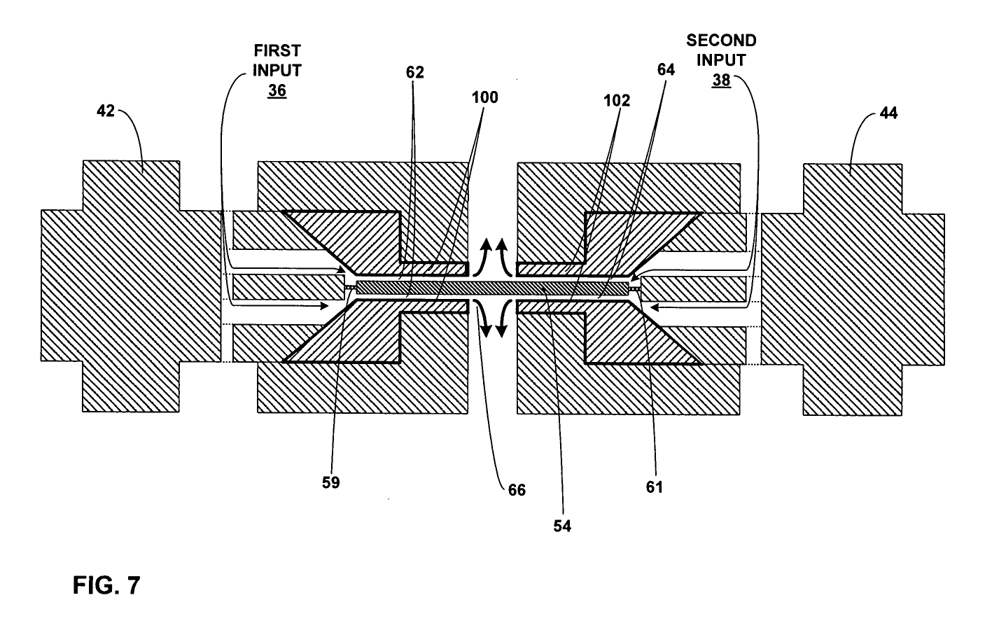

FIG. 7 is a cross-sectional side view of a portion of the annular fluid processing device 12 of FIG. 2 including annular flow channels with a circumferential outlet and rod 54 fixedly attached to comprise the inner surface of the flow paths. FIG. 7 is substantially similar to the example of FIG. 6. However, rod 54 is attached securely to rod supports 59 and 61 within fluid processing device 12. Rod supports 59 and 61 are located along the longitudinal axis of rod 54, outside of annular flow channels 62 and 64. While rod supports 59 and 61 are located at each end of rod 54, other embodiments may include rod supports contacting rod 54 on any other surface. For example, one or more rod supports may be located around the circumference of rod 54 near an end or in the middle of cylinders 100 or 102. Rod supports 59 and 61 may be constructed in a cylindrical shape or other structure that secures rod 54. In other embodiments, rod supports 59 and 61 may be cables that are under tension to securely tether rod 54 within cylinders 100 and 102.

Rod supports 59 and 61 prevent rod 54 from moving or vibrating within cylinders 100 and 102. Fixedly attaching rod 54 to rod supports 59 and 61 may be beneficial in some applications where fluid processing device 12 may be incorporated. For example, vibration of rod 54 may be unwanted if constant shear forces are desired at all times within cylinders 100 and 102. If a clog occurs within cylinder 56, short pulses of greater pressure from first input 36 or second input 38 may unclog any flow path, such as annular flow channels 62 or 64. Alternately, rod supports 59 and 61 may allow rod 54 to slightly move within cylinder 56. This movement may be related to rod 54 flexing or pressure differences between the first and second fluids.

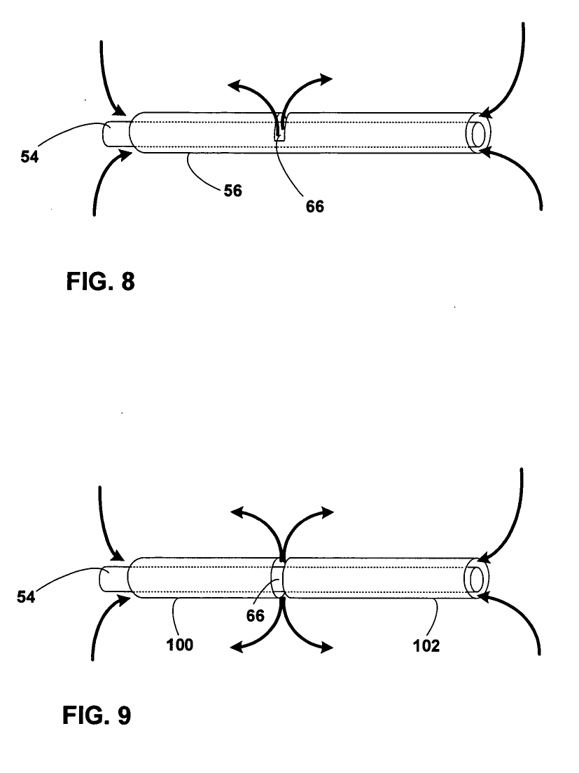

FIGS. 8 and 9 are conceptual perspective views of cylindrical rod 54 inside one or more flow path cylinders to define annular flow channels for fluid processing. As shown in FIG. 8, single flow path cylinder 56 can be formed with an outlet 66 that extends approximately 180 degrees around flow path cylinder 56, or to a lesser or greater extent, if desired. In any case, in the configuration of FIG. 8, outlet 66 has a fixed width. As indicated by the arrows, the first and second fluids are introduced to flow path cylinder 56 on opposing sides of the cylinder, and flow down toward the middle of the cylinder. The first fluid introduced on one side of cylinder 56 collides near outlet 66 with the second fluid introduced on the other side of cylinder 56, causing size reduction of dispersed phase in both fluids and mixing or reacting of both fluids to create a final combined product. Moreover, annular flow channels may enhance wall shear forces in cylinder 56 by increasing surface area associated with the opposing flow paths.

Rod 54 is positioned inside flow path cylinder 56, thereby creating flow paths that are annular. Rod 54 may have a length that is longer, shorter, or approximately the same length as flow path cylinder 56. Preferably, rod 54 may have a length that is longer than the length of flow path cylinder 56, but shorter than a distance between input nozzles (not shown) or gland nuts (not shown) through which the first or second fluids are introduced into flow path cylinder 56. Rod 54 may be substantially continuous throughout flow path cylinder 56, including the region adjacent outlet 66.

In an alternative embodiment shown in FIG. 9, two separate flow path cylinders 100 and 102 are used instead of the single flow path cylinder 56 of FIG. 8. The first fluid flows through flow path cylinder 100 and the second fluid flows through flow path cylinder 102. In this case, outlet 66 is formed by the lateral distance between both flow path cylinders 100 and 102. Accordingly, in that case, outlet 66 may be adjustable by moving one of flow path cylinders 100 and 102 relative to the other of flow path cylinders 100 and 102 along a common longitudinal axis of the cylinders 100, 102. In FIG. 9, outlet 66 extends around the full 360 degrees of flow path cylinders 100 and 102. If desired, part of this gap may be covered or blocked such that the final fluid product can escape from flow path cylinders 100 and 102 in limited directions or through exit channels (not shown).

Many embodiments of the disclosure have been described. Various modifications may be made without departing from the scope of the claims. For example, although the invention has been described in terms of application to industrial manufacturing of coatings, inks, paints, abrasive coatings, fertilizers, foods, beverages, pharmaceuticals, biological products, and agricultural products, the invention may be applicable to combination of any of a variety of fluids and/or materials to form dispersions, emulsions, suspensions, solutions, or the like. In addition, the invention may be applicable to combination of two or more fluids have different compositions or substantially identical compositions. These and other embodiments are within the scope of the following claims.

1. A fluid processing device comprising:
a first input channel that receives a first fluid;
a second input channel that receives a second fluid;
a first annular flow channel coupled to the first input channel that delivers the first fluid in a first direction;
a second annular flow channel coupled to the second input channel that delivers the second fluid in a second direction opposing the first direction such that the first and second fluid collide and combine with one another; and
an outlet that delivers a combined product of the first and second fluids.

2. The fluid processing device of claim 1, further comprising:
a flow path cylinder that defines an outer diameter of the first and second annular flow channels, the outlet being formed in the flow path cylinder; and
a rod, positioned within the flow path cylinder, that defines an inner diameter of the first and second annular flow channels.

3. The fluid processing device of claim 2, wherein the rod comprises a cylindrical rod that is not attached to any structure within the fluid processing device and is free to move under fluid dynamic forces generated relative to the flow path cylinder.

4. The fluid processing device of claim 1, further comprising:
a first flow path cylinder that defines an outer diameter of the first annular flow channel; and
a second flow path cylinder that defines an outer diameter of the second annular flow channel, the outlet being defined by a lateral distance between the first and second flow path cylinders.

5. The fluid processing device of claim 4, further comprising a rod positioned within the first and second flow path cylinders that defines an inner diameter of the first and second annular flow channels, wherein the rod comprises a cylindrical rod that is not attached to any structure within the fluid processing device and is free to move under fluid dynamic forces generated relative to the first and second flow path cylinders.

6. The fluid processing device of claim 5, wherein the outlet is adjustable by laterally moving one of the flow path cylinders relative to the other of the flow path cylinders.

7. The fluid processing device of claim 1, wherein the first fluid includes a first dispersed phase, and the second fluid includes a second dispersed phase.

8. The fluid processing device of claim 1, wherein at least one of the first and second fluids includes a dispersion of magnetic particles.

9. A fluid processing system comprising:
one or more pumps that pump at least of one of a first fluid and a second fluid;
one or more heat exchangers that change the temperature of at least one of the first fluid and the second fluid; and
a fluid processing device that processes the first fluid and the second fluid, the fluid processing device including:
a first annular flow channel that delivers the first fluid in a first direction;
a second annular flow channel that delivers the mixed fluid in a second direction opposing the first direction such that the first and second fluids collide and combine with one another; and
an outlet that delivers a combined product of the first and second fluids.

10. The fluid processing system of claim 9, further comprising:
a flow path cylinder that defines an outer diameter of the first and second annular flow channels, the outlet being formed in the flow path cylinder; and
a rod, positioned within the flow path cylinder, that defines an inner diameter of the first and second annular flow channels,
wherein the rod comprises a cylindrical rod that is not attached to any structure within the fluid processing device and is free to move under fluid dynamic forces generated relative to the flow path cylinder.

11. The fluid processing system of claim 9, the fluid processing device further including:
a first flow path cylinder that defines an outer diameter of the first annular flow channel;
a second flow path cylinder that defines an outer diameter of the second annular flow channel, the outlet being defined by a lateral distance between the first and second flow path cylinders; and
a rod positioned within the first and second flow path cylinders that defines an inner diameter of the first and second annular flow channels, wherein the rod is not attached to any structure within the fluid processing device and is free to move under fluid dynamic forces generated relative to the first and second flow path cylinders.

12. The fluid processing system of claim 11, wherein the outlet is adjustable by laterally moving one of the flow path cylinders relative to the other of the flow path cylinders.

13. The fluid processing system of claim 9, wherein the first fluid includes a first dispersed phase, and the second fluid includes a second dispersed phase.

14. The fluid processing system of claim 9, wherein at least one of the first and second fluids includes a dispersion of magnetic particles.

15. The fluid processing system of claim 9, wherein at least one of the first or second fluids flows through the one or more heat exchangers before flowing into the fluid processing device.

16. The fluid processing system of claim 15, wherein the first and second fluids are not re-pressurized following the heat exchangers prior to processing by the fluid processing device.

17. A method comprising:
directing a first fluid into a first annular flow channel that delivers the first fluid in a first direction;
directing a second fluid into a second annular flow channel that delivers the second fluid in a second direction opposing the first direction such that the first and second fluids collide and combine with one another; and
delivering a combined product of the first and second fluids via an outlet.

18. The method of claim 17, further comprising changing the temperature of at least one of the first fluid and the second fluid via one or more heat exchangers before the respective fluid is directed into the respective annular flow channel.

19. The method of claim 17, further comprising monitoring the temperatures of the first and second fluids.

20. The method of claim 19, further comprising detecting a clog in one of the annular flow channels based on the temperatures of at least one of the first and second fluids.

21. The method of claim 17, further comprising automatically unclogging one of the annular flow channels via movement of a cylindrical rod that forms an inner diameter of the two annular flow channels.

22. The method of claim 17, further comprising adjusting a size of the outlet.

23. The method of claim 17, further comprising increasing pressure of at least one of the first fluid and the second fluid to unclog one of the annular flow channels.

24. The method of claim 17, wherein the first fluid includes a first dispersed phase, and the second fluid includes a second dispersed phase.

25. The method of claim 17, wherein at least one of the first and second fluids includes a dispersion of magnetic particles.

26. A fluid processing system comprising:
one or more pumps that pump at least of one of a first fluid and a second fluid;
one or more heat exchangers that change the temperature of at least one of the first fluid and the second fluid;
a fluid processing device that processes the first and second fluids, the fluid processing device including a first annular flow channel that delivers the first fluid in a first direction, and a second annular flow channel that delivers the second fluid in a second direction opposing the first direction such that the first and second fluids collide and combine with one another; and
an outlet that delivers a combined product of the first and second fluids,
wherein the fluids flow through the one or more heat exchangers before flowing into the fluid processing device.

27. The system of claim 26, wherein the first and second fluids have different compositions.

28. The system of claim 26, wherein the first and second fluids have identical compositions.

29. The system of claim 26, wherein the first fluid includes a first dispersed phase, and the second fluid includes a second dispersed phase.

30. The system of claim 26, wherein at least one of the first and second fluids includes a dispersion of magnetic particles.
